(19) United States
(12) Patent Application Publication
(10) Pub. No.: US 2008/0035426 A1
(43) Pub. Date: Feb. 14, 2008

(54) Ladder tray

(76) Inventor: Frank W. Leuthner, Williamsport, PA (US)

Correspondence Address: Thomas R. Shaffer, 5 East Third Street, Coudersport, PA, 16915, US

(21) Appl. No.: 11/502,176

(22) Filed: Aug. 9, 2006

(51) Int. Cl. E06C 5/32

(52) U.S. Cl. 182/129

(57) ABSTRACT

A ladder tray has a tubular frame, a tray member and an adjustment bracket. The frame has an upper horizontal arm, a lower horizontal arm portion, a bridge portion connecting said upper and lower horizontal arms, and a support arm extending away from the bridge portion. A central portion of the tray is pivotally mounted to the upper horizontal arm portion. An adjustment bracket provides support and allows the tray to be secured to the ladder at different angled positions. The horizontal arms are received by adjacent hollow ladder rungs and a safety strap secures the tray to a side rail of the ladder.

### BACKGROUND OF THE INVENTION

1. Field of the Invention

The present invention relates to a ladder tray. More specifically, the invention relates to a tray pivotally mounted to a frame having upper and lower horizontal arm members received by adjacent hollow ladder rungs.

2. Description of the Prior Art

A variety of devices have been proposed for attaching paint cans, trays or stands to the rungs of a ladder. For example, Benninger, Jr., U.S. Pat. No. 3,223,369, discloses a device for hanging attachments to a ladder. A tube member 62 is inserted into the hollow rung of a ladder and is secured in place by bow shaped wire spring 84. Diagonal grooves 50 and 52 are provided to receive the handle 54 of a pale or other container 42.

Frederick, U.S. Pat. No. 3,459,277, discloses ladder jacks which include a U-shaped member 13. As shown in FIGS. 1 and 3, the device may be utilized to support a platform or tray. In this embodiment, tube or leg members 17 and 19 are screwed upon spaced apart ladder rungs by wing nuts 22 support a horizontal plank 26.

Blann, U.S. Pat. No. 4,099,693, discloses a container support which includes an elongated rod 11 which is adapted to be received within a hollow rung 19 of a ladder. Turned a portion 12 secures the device in position and bail engaging member 17 supports the handle 21 of a paint can or container 20.

Emmons, U.S. Pat. No. 3,829,051 discloses a detachable support tray for ladders. A tray 10 is supported on a ladder rung 112 (FIG. 5) by hook 70. Additional support is provided by arm 88 and hook 44 which connect to a ladder side rail 104.

Broden, U.S. Pat. No. 3,495,683, discloses a roller pan holder for ladders. The device includes a rod 36 mounted to end 28 of tray 18 which is inserted in to a lower hollow ladder rung 12 and a rod 42 which is inserted in to an upper hollow ladder rung. A chain connects rod 42 to an end flange 26 of tray 18.

Riley, U.S. Pat. No. 4,489,911, discloses a ladder-mountable tray device which is designed to hold tray 3 substantially horizontal. Adjacent one end of the tray 4, an arm 4 is mounted to the underside of the tray by a U-shaped bracket 5. The arm 4 is a nylon tubular member 6 having a threaded member 7 secured at one end by a screw 8 and a threaded knob 10 forms a stop means. Arm 4 is received within an upper hollow rung of ladder 2. An L-shaped member 13 and an L-shaped member 14 are telescopically joined together by clamp 15. Member 14 has an end which is received within a lower hollow rung of ladder 2.

There remains a need for a ladder mounted tray which is easily formed out of readily available materials, which is inexpensive to manufacturer, which is adjustable to non-horizontal positions, and one which has a bracket mounted to a central portion of the tray to allow access to the tray from varying heights on the ladder. There also remains a need for a ladder tray which is simple to use, quickly installed on a ladder and which safely holds a variety of objects for the user.

### SUMMARY OF THE INVENTION

In its simplest form, the ladder tray of the present invention comprises: a) a tubular frame, said frame having an upper horizontal arm portion having an end sized to be received by an upper hollow rung of a ladder, said frame having a lower horizontal arm portion having an end sized to be received by an adjacent lower hollow rung of a ladder, said frame having a bridge portion connecting said upper horizontal arm portion and said lower horizontal arm portion, and a support arm extending away from said bridge portion; b) a tray member having an upper surface, a lower surface, a first tray end, a second tray end and a central tray portion, said central portion pivotally mounted to said upper horizontal arm portion; and c) an adjustment bracket having a first bracket end pivotally attached to said first tray end, said adjustment bracket extending longitudinally downward from said tray and being adjustable attached at a selected location along its length to said support arm, whereby the tray may be secured to the ladder at different selected angled position by attaching said support arm to a different selected location.

Preferably the ladder tray further comprises a safety strap to removably secure the ladder tray to a side rail of a ladder when the ladder tray is mounted on a ladder. The safety strap preferably further comprises two strap members attached to an inner side wall of the tray, said strap members each including a surface having a Velcro material thereon whereby said strap members can be removably attached together to security tray to said side rail.

Preferably, an inner side wall of the tray includes a notch sized to receive a side rail of a ladder. Preferably the tray includes a plurality of holes sized to receive various tools and implements.

Preferably, the adjustment bracket includes a longitudinal groove therein and wherein a threaded knob secures said adjustment bracket at a desired location to said bridge portion, said bridge portion including an end having a screw hole adapted to receive said threaded knob.

Preferably, tubular frame is formed from various readily available PVC pipe components such as ¾ inch diameter PVC pipe components.

Preferably, the bridge portion comprises a 90° elbow and a pair of 45° elbows.

Preferably, the support arm includes a T member, a 45° elbow, a threaded insert centered in an end cap and a threaded knob.

Preferably, the tray includes a pair of spaced apart support members mounted to said lower surface of said tray, said support members having a generally U-shaped notch therein sized to receive said upper horizontal arm portion.

### BRIEF DESCRIPTION OF THE FIGURES

FIG. 1 is a perspective view of the ladder tray of the present invention.

FIG. 2 is side elevational view of the ladder tray of the present invention.

FIG. 3 is a top plan view of the ladder tray of the present invention.

FIG. 4 is a perspective view of the ladder tray as mounted to a ladder.

FIG. 5 is a side elevational view of the adjustment bracket of the present invention.

FIG. 6 is a side elevational view of an the tubular frame showing the threaded knob.

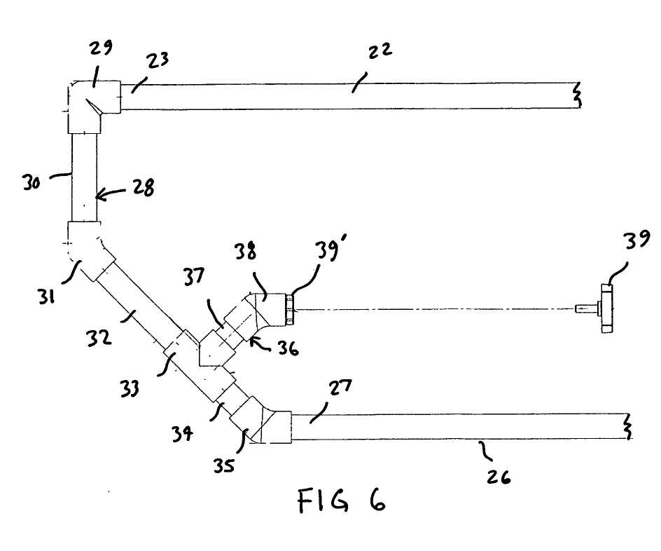

FIG. 7 is an end elevational view of the tray showing the tray support members of the present invention.

FIG. 8 is a perspective view of the adjustment bracket of the present invention.

### DETAILED DESCRIPTION OF THE PREFERRED EMBODIMENTS

Referring to the figures, the ladder tray 10 of the present invention includes a tubular frame 20, a tray member 40, and adjustment bracket 60 and a safety strap 80. The tubular frame 20 is fabricated from the ¾ inch PVC piping components which are glued together in a manner well known in the art. The frame 20 includes an upper horizontal arm portion 22 which includes a first and 21 in the second end 23. The tubular frame and 20 also includes a lower horizontal arm portion 26 which includes a first and 25 and a second end 27.

A bridge portion 28 interconnects end 23 of horizontal arm 22 with end 27 of horizontal arm a 26. The bridge portion 28 includes a 90° elbow 29, straight pipe 30, 45° elbow 31, straight pipe 32, TEE 33, straight pipe 34 and a 45° elbow 35. The tubular frame 20 also includes a support arm a 36 which is formed by components TEE 33, straight pipe 37, and 45° elbow 38. Elbow 38 includes a threaded insert 39′ (such as a McMASTER.COM 93365A760) which is centered in an end cap for said elbow. A separate threaded knob 39 which has a flute head (such as a McMASTER.COM 93005A551) is provided. The threaded knob 39 passes through the groove 66 and, when fully tightened in to threaded insert 39′ secures the support arm 36 to the adjustment bracket 60 that a desired location along the length of the adjustment bracket 60. It will be obvious that my changing the location of the attachment will result in securing the tray 40 in any desired angled position. Users will often choose to secure the tray 40 in a horizontal position but the adjustment bracket 60 allows the tray to be secured at any desired angle. When the threaded knob 39 is fully tightened, the tray 40 will be securely held in a rigid position relative to the tubular frame 20.

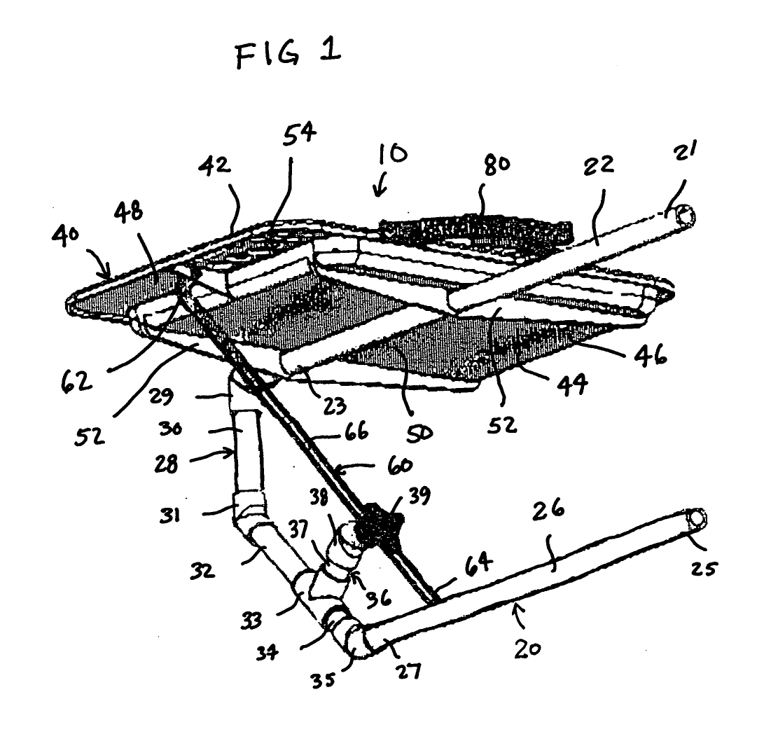

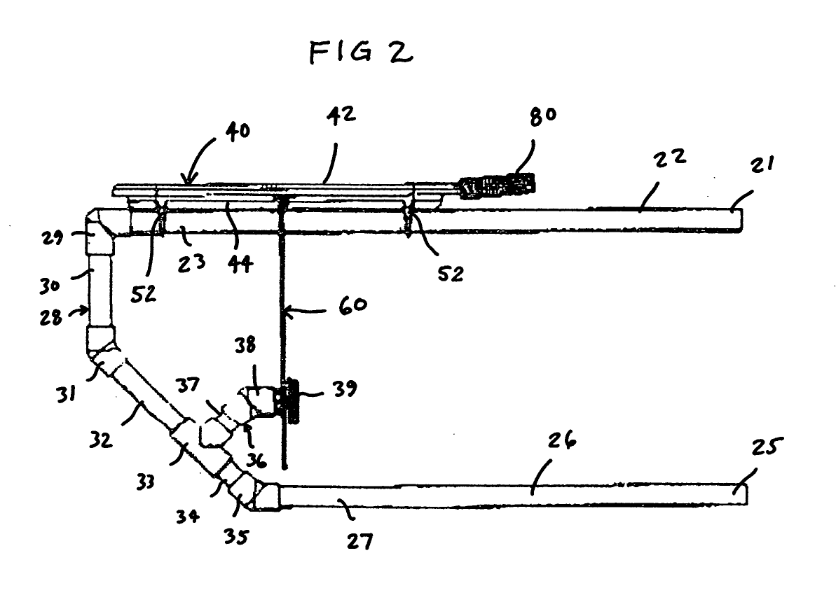

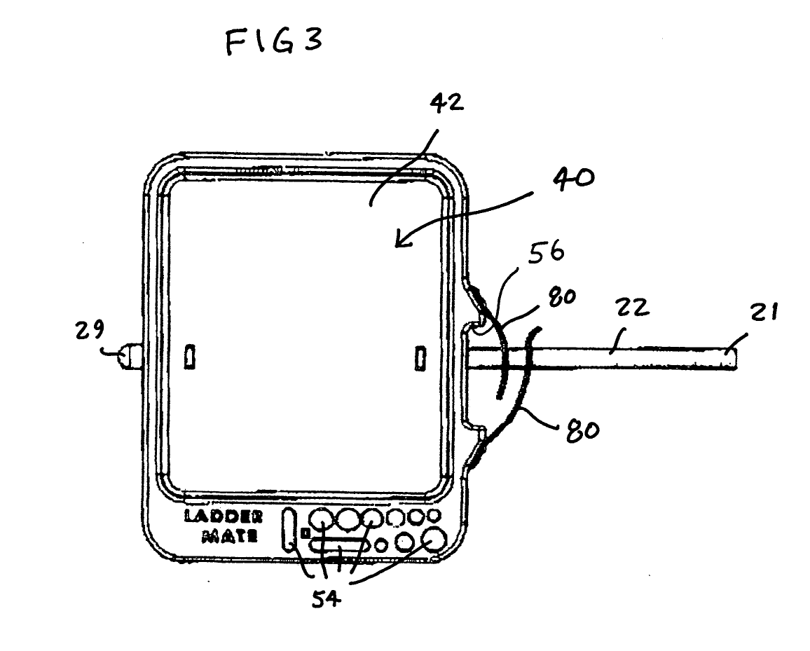

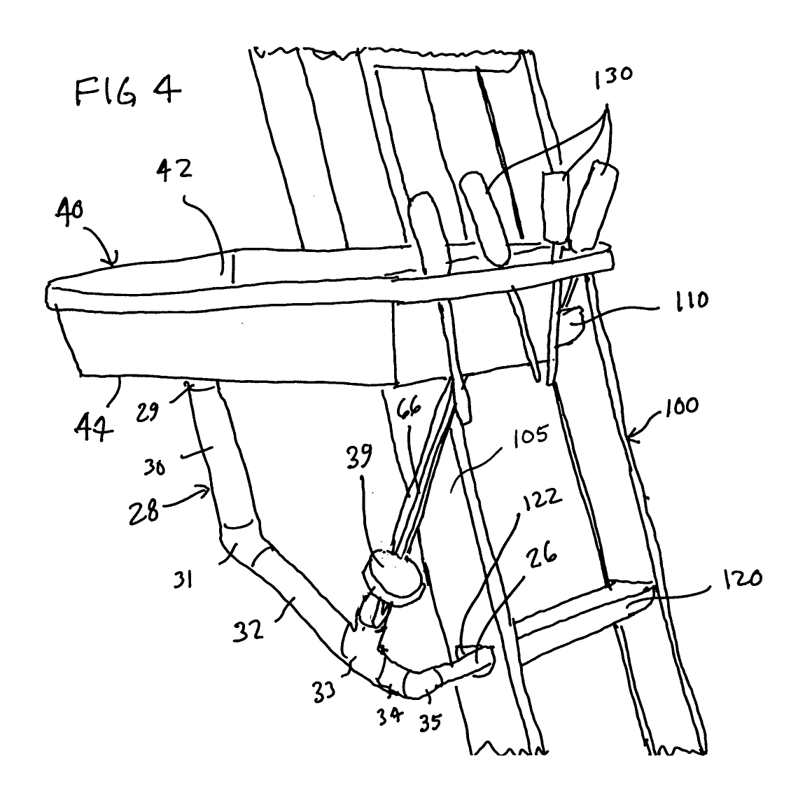

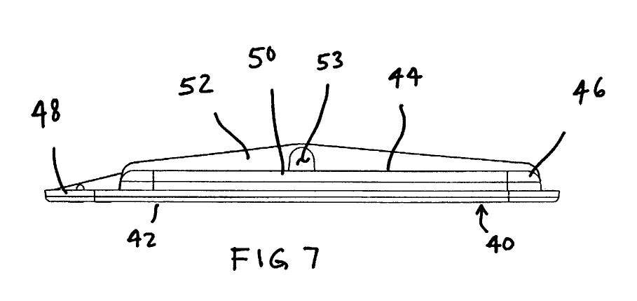

The tray member 40 includes an upper surface 42, a lower surface 44, a first end 46, a second end 48 and a central portion 50. As shown in FIGS. 1-3, central portion 50 of tray member 40 is pivotally mounted the upper horizontal arm 22. As shown in FIG. 1 and FIG. 7, a pair of spaced apart frame support members 52 are mounted on the lower surface 44 of the tray 40. The support members 52 are provided with a generally U-shaped opening 53 (FIG. 7) sized to receive upper horizontal arm member 22. The tray member 40 preferably includes a plurality of openings 54 of various sizes and shapes adapted to receive and secure various objects onto the tray 40. For example, a variety of tools 130 such as screwdrivers, hammers and the like may be supported by said tray openings 54. This feature of the invention is best shown in FIGS. 3 and 4. Preferably, the tray member also includes a notch 56 which is adapted to receive a side rail 105 of ladder 100.

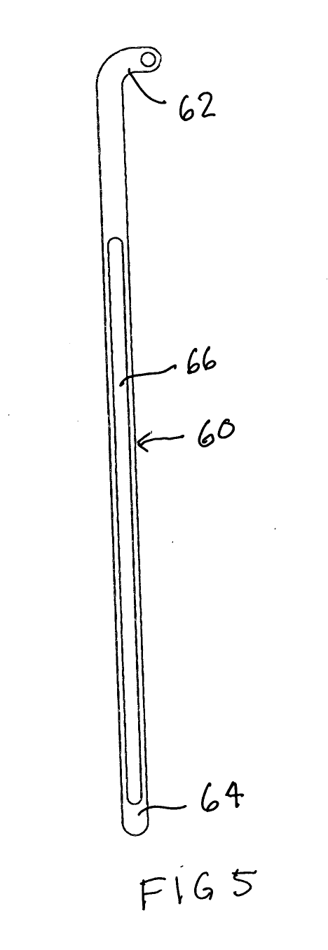

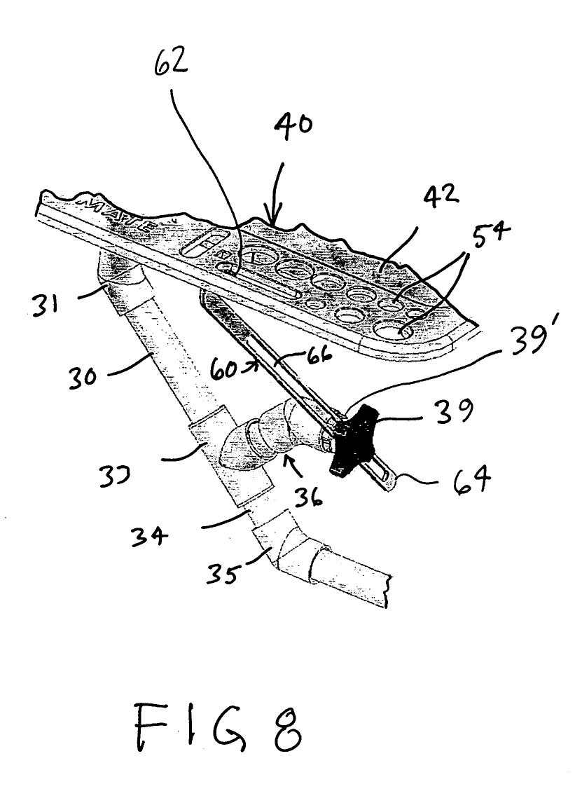

The adjustment bracket 60, as best shown in FIGS. 1, 5 and 8, includes a first end 62 which is pivotally mounted to second and 48 of tray member 40. The adjustment bracket 60 includes a second end 64 which extends longitudinally downward away from the tray 40. Adjustment bracket 60 includes a central groove 66 which is adapted to receive threaded knob 39.

A safety strap 80 consisting of two strips of Velcro material is utilized to secure the ladder tray 10 onto a side rail 105 of ladder 100. It will be obvious that various other types of belts or buckles or other strap, rope, chain or wire members could be utilized in place of Velcro straps. When in use, as shown in FIG. 4, end 21 of horizontal arm member 22 is inserted into the upper hollow rung 110 of ladder 100. Similarly, end 25 of horizontal arm member 26 is inserted in to the adjacent lower hollow rung 120 of ladder 100. The central portion 50 of tray 40 is pivotally supported by the upper horizontal arm member 22. The user may loosen the threaded knob 39 and tip the tray to any desired angled position and retighten the knob 39. The safety strap 80 is then securely tightened around side rail 105 of ladder 100.

The present invention provides an extremely economical and simple solution to a long-standing problem of providing a safe and secure location for necessary tools and supplies on a ladder. Because the present invention mounts a central portion 50 of the tray 40 over the upper horizontal or member 22, the tray 40 does not extend in to great a distance in front of or behind the ladder on which it is mounted. Such arrangement also keeps the center of mass of the tray 40 to the greatest extent possible supported directly over a ladder rail 105 so that little weight need be carried by the adjustment bracket 60. Because the fray member is fabricated from PVC piping components, the device is strong, light weight and may be easily and economically manufactured.

It is to be understood that while certain forms of the present invention have been illustrated and described herein, the present invention is not to be limited to the specific forms or arrangements of parts described and shown.

I claim:

1. A ladder tray comprising:
a) a tubular frame, said frame having an upper horizontal arm portion having an end sized to be received by an upper hollow rung of a ladder, said frame having a lower horizontal arm portion having an end sized to be received by an adjacent lower hollow rung of a ladder, said frame having a bridge portion connecting said upper horizontal arm portion and said lower horizontal arm portion, and a support arm extending away from said bridge portion;
b) a tray member having an upper surface, a lower surface, a first tray end, a second tray end and a central tray portion, said central portion pivotally mounted to said upper horizontal arm portion; and
c) an adjustment bracket having a first bracket end pivotally attached to said first tray end, said adjustment bracket extending longitudinally downward from said tray and being adjustable attached at a selected location along its length to said support arm, whereby the tray may be secured to the ladder at different selected angled position by attaching said support arm to a different selected location.

2. A ladder tray according to claim 1 further comprising a safety strap to removably secure the ladder tray to a side rail of a ladder when the ladder tray is mounted on a ladder.

3. The ladder tray according to claim 2 wherein said safety strap further comprises two strap members attached to an inner side wall of the tray, said strap members each including a surface having a Velcro material thereon whereby said strap members can be removably attached together to security tray to said side rail.

4. A ladder tray according to claim 1 wherein an inner side wall of the tray includes a notch sized to receive a side rail of a ladder.

5. A ladder tray according to claim 1 wherein said adjustment bracket includes a longitudinal groove therein and wherein a threaded knob secures said adjustment bracket at a desired location to said bridge portion, said bridge portion including an end having a screw hole adapted to receive said threaded knob.

6. A ladder tray according to claim 1 wherein said tray includes a plurality of holes sized to receive various tools and implements.

7. A ladder tray according to claim 1 wherein said tubular frame is formed from various readily available PVC pipe components.

8. A ladder tray according to claim 7 wherein said pipe components are formed from ¾ inch diameter PVC pipe components.

9. A ladder tray according to claim 7 wherein bridge portion comprises a 90° elbow and a pair of 45° elbows.

10. A ladder tray according to claim 7 wherein said support arm includes a T member, a 45° elbow, a threaded insert centered in an end cap and a threaded knob.

11. A ladder tray according to claim 1 wherein said tray includes a pair of spaced apart support members mounted to said lower surface of said tray, said support members having a generally U-shaped notch therein sized to receive said upper horizontal arm portion.
